(19) United States
(12) Patent Application Publication
(10) Pub. No.: US 2007/0127131 A1
(43) Pub. Date: Jun. 7, 2007

(54) Device and method for homogenizing optical beams

(75) Inventors: Vitalij Lissotschenko, Frondenberg (DE); Aleksei Mikhailov, Dortmund (DE); Iouri Mikliaev, Cheljabinsk (RU); Maxim Darsht, Dortmund (DE)

Correspondence Address: LERNER GREENBERG STEMER LLP, P O BOX 2480, HOLLYWOOD, FL, 33022-2480, US

(73) Assignee: Hentze-Lissotschenko Patentverwaltungs GmbH & Co. KG

(21) Appl. No.: 11/589,270

(22) Filed: Oct. 26, 2006

Related U.S. Application Data
(63) Continuation of application No. PCT/EP05/03751, filed on Apr. 9, 2005.

(30) Foreign Application Priority Data
Apr. 26, 2004 (DE) 10 2004 020 250.8

(51) Int. Cl. G02B 27/10

(52) U.S. Cl. 359/626

(57) ABSTRACT

A device for homogenizing optical beams contains at least one optically functional boundary surface through which a beam to be homogenized can pass or at which a beam to be homogenized can be reflected. A plurality of lens elements or mirror elements are disposed on the at least one optically functional boundary surface. The lens elements or the mirror elements each have such a curvature in their edge regions that diffraction-related effects are reduced as a result.

### CROSS-REFERENCE TO RELATED APPLICATIONS

This is a continuing application, under 35 U.S.C. §120, of copending international application PCT/EP2005/003751, filed Apr. 9, 2005, which designated the United States; this application also claims the priority, under 35 U.S.C. §119, of German patent application DE 10 2004 020 250.8, filed Apr. 26, 2004; the prior applications are herewith incorporated by reference in their entirety.

### BACKGROUND OF THE INVENTION

### Field of the Invention

The present invention relates to a device for homogenizing optical beams. The device contains at least one optically functional boundary surface through which a beam to be homogenized can pass or at which a beam to be homogenized can be reflected, and a plurality of lens elements or mirror elements which are disposed on the at least one optically functional boundary surface. Furthermore, the invention relates to a method for manufacturing a device for homogenizing optical beams, having at least one optically functional boundary surface through which a beam to be homogenized can pass or at which a beam to be homogenized can be reflected, and a plurality of lens elements or mirror elements which are disposed on the at least one optically functional boundary surface.

U.S. Pat. No. 6,239,913 B1 discloses a device and a method of the type mentioned at the beginning. The device described therein has a transparent substrate in which arrays of cylinder lenses are disposed both on a light entry surface and on a light exit surface. The arrays of cylinder lenses have cylinder axes that are perpendicular to one another. The individual cylinder lenses can have a second order spherical or aspherical cross-section. In order to homogenize the beams, for example collimated laser radiation is guided through the device and adjacent to the device is concentrated in one working plane by a collecting lens that serves as a Fourier lens. The light that is refracted by the individual cylinder lens element is superimposed in the working plane by the Fourier lens in such a way that the original laser radiation is homogenized.

The disadvantage with the device of the aforementioned type is that owing to diffraction effects the light distribution of the light that has passed through individual lens elements has marked fluctuations in intensity (see FIG. 2 in this respect). The fluctuations in intensity of the light distribution of an individual lens element are also not cancelled out during the superimposition of the light from all the lens elements because the light that has passed through the individual lens element is superimposed in an essentially similar way in the working plane for each lens element.

### SUMMARY OF THE INVENTION

It is accordingly an object of the invention to provide a device and a method for homogenizing optical beams that overcome the above-mentioned disadvantages of the prior art devices and methods of this general type, which can produce homogenized light with low fluctuations in intensity. Furthermore, a method for manufacturing a device for homogenizing optical beams with which the homogenized light has lower fluctuations in intensity is to be specified.

With the foregoing and other objects in view there is provided, in accordance with the invention, a device for homogenizing optical beams. The device includes at least one optically functional boundary surface through which a beam to be homogenized can pass or at which the beam to be homogenized can be reflected. A plurality of elements, being either lens elements or mirror elements, are disposed on the at least one optically functional boundary surface. The elements each have an edge region with a curvature for reducing diffraction-related effects.

According to the invention, there is provision for the lens elements or the mirror elements each to have such a curvature in their edge regions that diffraction-related effects are reduced as a result. The effects to be reduced are predominantly effects which resemble edge diffraction effects, the inventive change in the edge region permitting such edge diffraction effects to be changed, in particular to be blurred, in such a way that overall the fluctuation in intensity of the light distribution which has passed through an individual lens element or of the light distribution which has been reflected at an individual mirror element can be greatly reduced.

The inventive devices are suitable for a wide spectral range from the far infrared region to the x-ray region. The use of mirror elements instead of lens elements proves extremely appropriate in particular in the VUV, XUV and x-ray ranges.

There is also the possibility of providing more than one optionally functional boundary surface, for example two or four. In this context, the lens elements or mirror elements of all the optically functional boundary surfaces, or only some of them, can be changed so that better homogenization of the light is achieved.

According to a further embodiment of the invention, it is possible to provide that the lens elements or the mirror elements have, in a central region, a cross section which corresponds substantially to a second order aspherical cross section such as, for example, a hyperbolic or parabolic cross section. Accordingly, it is possible to provide for the lens elements or the mirror elements to have, in their edge regions, a cross section that deviates from a second order aspherical cross section, in particular deviates to a very great extent. This difference can be embodied in such a way that the lens elements or the mirror elements have, in their edge regions, a cross section which is dominated by relatively high orders of a polynomial, in particular by relatively high even-numbered orders of a polynomial. Under certain circumstances, it is possible in this context only to describe the edge regions mathematically separately from the central region by a polynomial. The domination of the cross section in the edge regions of the lens elements or of the mirror elements by relatively high orders of a polynomial allows the abovementioned edge diffraction effects to be influenced selectively so that the light distribution which exits the homogenizer or the individual lens elements of the homogenizer or is reflected by the individual mirror elements can be smoothed off comparatively effectively.

According to another embodiment of the invention, each of the lens elements or of the mirror elements is provided with a wave-shaped or sinusoidal structure. In particular it is possible in this context, for the periodicity of the structure to be smaller, in particular small compared to the periodicity with which the individual lens elements or mirror elements are disposed one next to the other. For example, it is possible here, for each of the lens elements or of the mirror elements to have a basic structure on which the wave-shaped or sinusoidal structure is based and which is second order spherical or aspherical. As a result of the wave-shaped or sinusoidal structure of each of the lens elements or mirror elements, the intensity of the light distribution of the homogenizer can be averaged so that overall the light distribution can be made more uniform.

In a method according to the invention a device is produced for homogenizing optical beams having at least one optically functional boundary surface and a plurality of lens elements or mirror elements on the optically functional boundary surface. The light distribution of light passing through an individual lens element of the plurality of lens elements or of light reflected by an individual mirror element of the plurality of mirror elements is determined. A structure that is complementary to the determined light distribution is applied to each of the lens elements or of the mirror elements.

In particular it is possible for the applied structure to have a greater amplitude in the edge regions of the lens elements or of the mirror elements than in the central region of the lens elements or of the mirror elements. In this context it is possible for the lens elements or mirror elements that are produced in the first method step to have a regular cross section, in particular a second order spherical or aspherical cross section. The lens elements or mirror elements that are produced in the first method step can thus be manufactured with simple measures. The complementary structure which is applied to the lenses or mirrors after the determination of the light distribution can be adapted, with corresponding fabrication expenditure, precisely to the diffraction-related, expected disruption of the light distribution in such a way that the light which passes through a homogenizing device with such a structure has very uniform light distribution after passing through the device or very uniform light distribution after reflection at the device when corresponding mirror elements are used.

Other features which are considered as characteristic for the invention are set forth in the appended claims.

Although the invention is illustrated and described herein as embodied in a device and a method for homogenizing optical beams, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A is a diagrammatic, side view of a device according to the invention;

FIG. 1B is a diagrammatic, side view of the device turned through 90° with respect to FIG. 1A;

FIG. 2 is a graph illustrating a light distribution of light passing through a lens element according to the prior art;

FIG. 3 is a graph illustrating a light distribution of light passing through a lens element of the device according to the invention;

FIG. 4 is a diagrammatic, cross-sectional view of an individual convex lens element of a device according to the invention compared to an individual lens element according to the prior art;

FIG. 5 is a detailed, sectional view of an edge region of the cross section of the lens element of the device according to the invention as in FIG. 4;

FIG. 6 is a diagrammatic, cross-sectional view through a further embodiment of a concave lens element of a device according to the invention;

FIG. 7 is a detailed, view of the cross section in FIG. 6, pointing towards the edge of the lens element; and

FIG. 8 is a graph illustrating the light distribution of light that has passed through the lens element according to FIG. 6.

### DESCRIPTION OF THE PREFERRED EMBODIMENTS

The invention will be described below using the example of lens elements through which light that is to be homogenized passes. Mirror elements which, according to the invention, can also be used for homogenization, may be made similar or precisely the same as the lens elements, with the difference that they are configured so as to be at least partially reflective to the wavelength of the light to be homogenized. For this purpose, it is possible, for example, to provide the lens elements described below with a corresponding reflective coating. The light to be homogenized may then, for example, be reflected at the individual mirror elements at an angle that is unequal to zero.

In some of the figures, Cartesian coordinate systems are depicted in order to clarify the method according to the invention better.

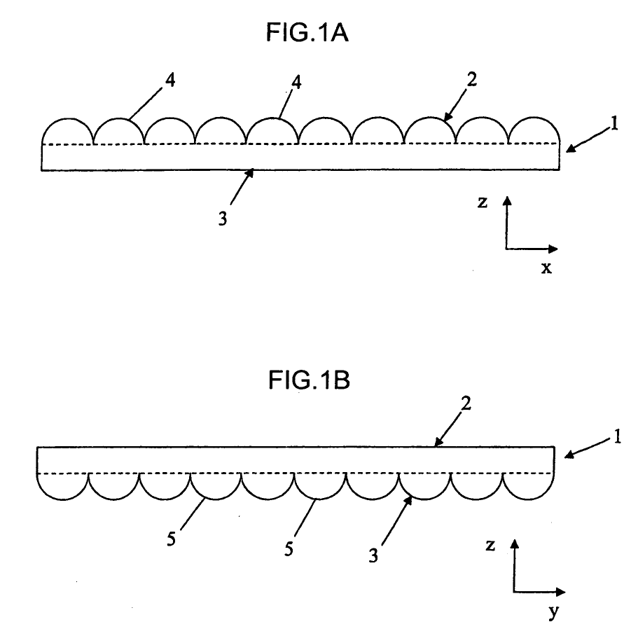

Referring now to the figures of the drawing in detail and first, particularly, to FIGS. 1A and 1B thereof, there are shown schematic views of an exemplary embodiment of a device according to the invention for homogenizing optical beams. In particular, FIGS. 1A and 1B show a substrate 1 made of a transparent material with an entry surface 2 and an exit surface 3 for light. A plurality of lens elements 4 which are disposed parallel to one another and which are embodied as cylinder lenses are provided on the entry surface 2. Cylinder axes of the cylinder lenses 4 extend in the Y direction. Likewise, a plurality of lens elements 5, which are also embodied as cylinder lenses that are disposed parallel to one another and spaced apart from one another, are disposed on the exit surface 3. The cylinder axes of the lens elements 5 extend in the X direction and are thus oriented perpendicularly to the cylinder axes of the lens elements 4.

The light beams which have passed through the lens elements 4, 5 embodied in a cross configuration with respect to one another as cylinder lenses when light has passed through the entry surface 2 and the exit surface 3 are diffracted both in the X direction and in the Y direction so that the lens elements 4, 5 have a similar effect in their interaction to a plurality of spherical lens elements. According to the invention it is perfectly possible for a two-dimensional array of spherical lens elements to be used instead of cylinder lenses in a cross configuration. Such an array can be disposed on both the entry surface 2 and the exit surface 3 as well as only on the entry surface 2 or only on the exit surface 3. Furthermore, it is possible to arrange an array of cylinder lenses only on the entry surface 2 or only on the exit surface 3 so that the light is diffracted only with respect to one of the directions XY. Furthermore, the lens elements or mirror elements which are disposed one next to the other can also be alternately of concave configuration and of convex configuration on one of the optically functional boundary surfaces or on each of the surfaces, in order to avoid losses in the junction region between individual lens elements or mirror elements.

The embodiment of a device according to the invention which is depicted in FIGS. 1A and 1B can be used to homogenize a laser beam, in which case, for example, parallel light is directed onto the device and a collecting lens can be provided in the beam direction behind the device which collecting lens serves as a Fourier lens and which causes the light which has passed through a large number of lens elements 4, 5, or through all of the lens elements 4, 5, to be superimposed in the focal plane of the Fourier lens. Such structures are sufficiently known from the prior art. Alternatively, a slightly different inclination of the individual lens elements 4, 5 can bring about superimposition in the far field. In this way it is possible to dispense with a separate Fourier lens.

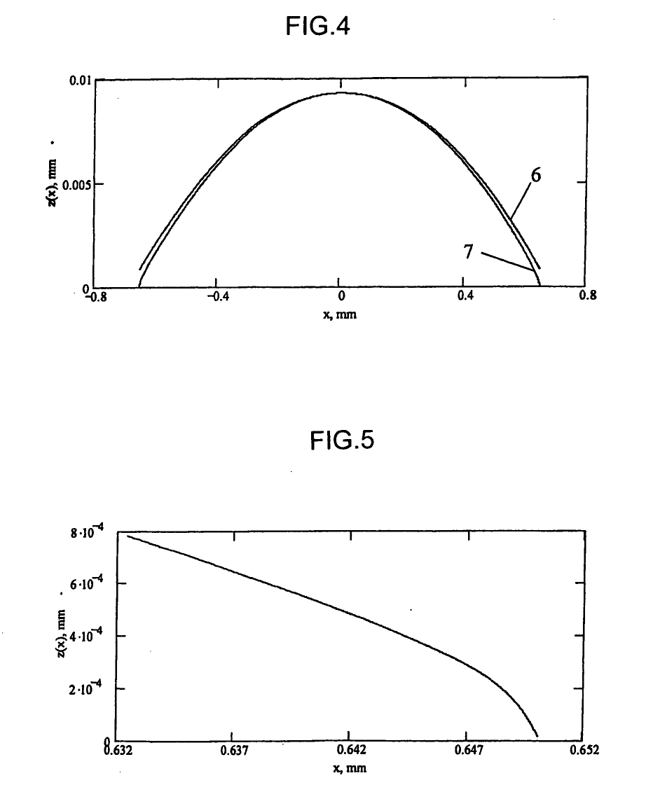

In FIGS. 1A and 1B, the individual lens elements 4, 5 are indicated schematically by a semicircle. The form of the individual lens elements is illustrated only in a roughly simplified fashion. The form of an embodiment of a lens element of a device according to the invention is shown in detail in FIG. 4. In particular, in FIG. 4 the graphic at the top shows a cross section 6 of a cylinder lens which is known from the prior art and has an substantially second order aspherical cross section. The lower graphic in FIG. 4 shows a cross section 7 of a lens element of a first embodiment of a device according to the invention. From FIG. 4 it is apparent that the cross section 7 differs, in particular in the edge region of the lens element, from the second order aspherical cross section 6 according to the prior art. In FIG. 4, the extent of the lens element in the Z direction (see in this respect FIGS. 1A and 1B) is plotted towards the top. The abscissa of the graphic according to FIG. 4 shows the X coordinate of the lens element in millimeters, the 0 being arranged at the center point of the cross section of the lens element here. The graphic according to FIG. 4 shows that the deviation of the cross section 7 of the lens element of the device according to the invention from the parabolic cross section 6 according to the prior art becomes marked for X values≦−0.4 mm or ≧0.4 mm.

In particular, from FIG. 5 it is apparent that in the edge region of the lens element the cross section is curved to a significantly greater degree than in the adjoining region. In particular, a very clear increase in the curvature of the cross section is apparent in the case of X values≦−0.647 mm or in the case of X values≧0.647.

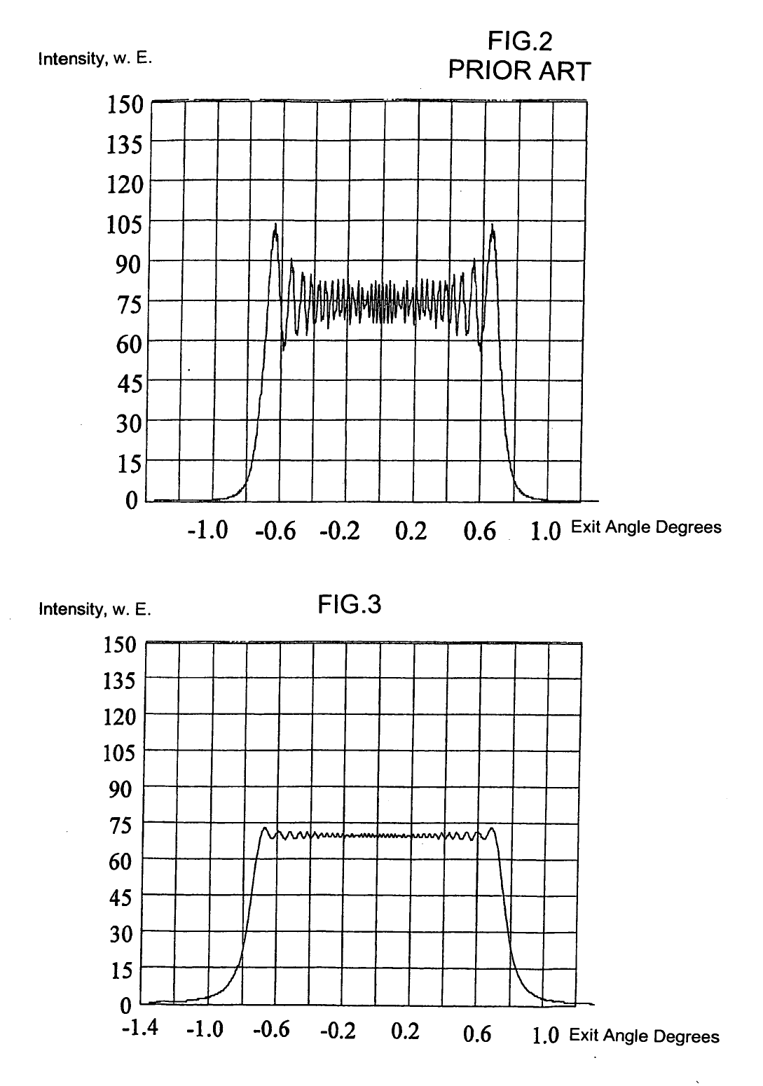

FIG. 2 is a graph of light distribution with intensity plotted against an exit angle for a lens element with a second order aspherical cross section 6 according to the prior art. In particular, disruptive diffraction-related fluctuations in intensity for different light exit angles are shown here. FIG. 3 shows, on the same scale, the light distribution of the lens element 4, 5 with the cross section 7 according to FIG. 4 of the device according to the invention. It is clearly apparent that the diffraction-related fluctuations in intensity are significantly smaller here, which is due to the deviation of the cross section from the second order aspheric in the edge region of the lens element 4, 5.

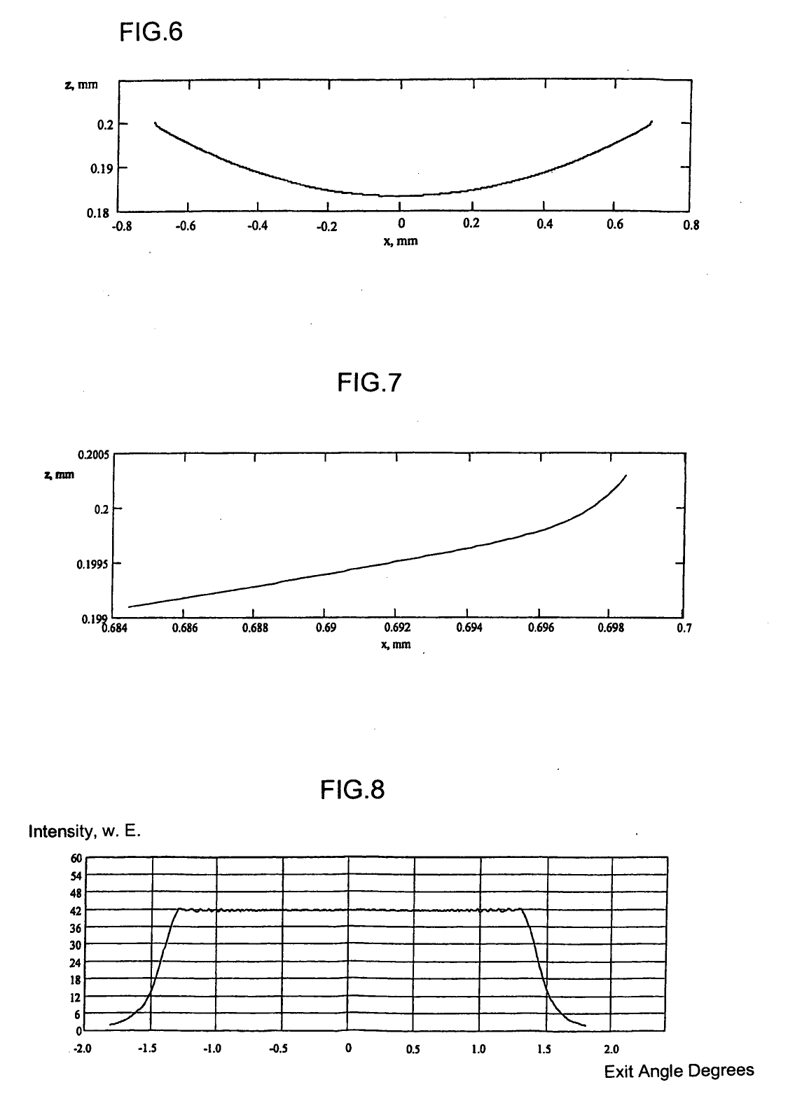

FIGS. 6 and 7 show a second embodiment of a lens element 4, 5 of a device according to the invention. In particular, FIG. 7 shows that this embodiment also has a strong increase in the curvature in its edge region. FIG. 8 shows the light distribution of light which has passed through such a lens element 4, 5, in terms of intensity as a function of the exit angle. The light distribution has virtually imperceptible fluctuations in intensity for different exit angles, which is also due here to the specific shape of the lens element 4, 5 in its edge region.

In the text that follows, the example of the cross section of a lens element 4, 5 which is illustrated in FIGS. 6 and 7 is described in detail. In particular, the cross section can be represented mathematically in certain parts as a twelfth order polynomial, according to the following formula:
Z(x)=U₀+U₁·|x|+U₂·|x|²+U₃·|x|³+U₄·|x|⁴+U₅·|x|⁵+U₆·|x|⁶+U₇·|x|⁷+U₈·|x|⁸+U₉·|x|⁹+U₁₀·|x|¹⁰+U₁₁·|x|¹¹+U₁₂·|x|¹²
having the following coefficients:
In a first x value range where 0≦|x|<0.560
U₀=−1.66·10⁻²
U₁=0
U₂=−3.34·10⁻²
U₃=0
U₄=−2.48·10⁻⁵
U₅=0
U₆=−1.00·10⁻⁷
U₇=0
U₈=−5.57·10⁻⁷
U₉=0
U₁₀=1.81·10⁻⁶
U₁₁=0
U₁₂=2.18·10⁻⁶
In a second x value range where 0.560≦|x|<0.650
U₀=−6.15·10⁻³
U₁=3.74·⁻²
U₂=−3.34·10⁻²
U₃=7.67·10⁻⁴
U₄=−2.96·10⁻²
U₅=6.42·10⁻¹
U₆=−1.70·10¹
U₇=3.55·10²
U₈=−7.34·10⁰
U₉=−2.58·10⁴
U₁₀=1.21·10⁵
U₁₁=5.83·10⁵
U₁₂=−2.66·10⁶
In a third x value range where 0.650≦|x|<0.688
U₀=−2.51·10⁻³
U₁=4.39·10⁻²
U₂=4.95·10⁻²
U₃=2.16·10⁻¹
U₄=4.29·10¹
U₅=−6.24·10³
U₆=6.70·10⁵
U₇=−4.61·10⁷
U₈=2.11·10⁹
U₉=−6.38·10¹⁰
U₁₀=1.23·10¹²
U₁₁=−1.36·10¹³
U₁₂=6.70·10¹³
In a fourth x value range where 0.688≦|x|<0.698
U₀=−7.20·10⁻⁴
U₁=5.41·10⁻²
U₂=6.32·10⁻¹
U₃=−2.49·10²
U₄=2.84·10⁵
U₅=−1.71·10⁸
U₆=6.62·10¹⁰
U₇=−1.69·10¹³
U₈=2.88·10¹⁵
U₉=−3.26·10¹⁷
U₁₀=2.35·10¹⁹
U₁₁=−9.72·10²⁰
U₁₂=1.78·10²²

It becomes apparent that in the central region of the lens element the shape of the cross section is determined substantially by the coefficient U₂, which is assigned to the quadratic term of X, over a very extended range up to approximately 0.56 mm from the center point. In other words, a substantially aspherical second order embodiment of the cross section of the lens element is obtained in the central region. Compared to the comparatively large coefficient U₂, the further coefficients U₄, U₆, U₈, U₁₀, U₁₂ are negligibly small. Furthermore it also becomes apparent that all the uneven coefficients U₁, U₃, U₅, U₇, U₉, U₁₁ are equal to zero.

In the second X value range between 0.56 and 0.65 the shape of the cross section of the lens element is no longer predominantly determined by the coefficient U₂ because, for example, the coefficient U₁ which is assigned to the linear term of X has a comparable order of magnitude to that of U₂. Furthermore, coefficients that are assigned to relatively high orders of X are significantly larger so that they are also significant in some cases; reference will be made here by way of example to the coefficient U₁₂.

This increase in the coefficients assigned to the relatively high orders of X continues in the third value range and in particular in the fourth value range where the coefficient U₁₂ is more than 20 orders of magnitude larger than the coefficient U₂.

In a further non-illustrated embodiment of a device according to the invention, lenses with a substantially regular structure and, for example, a second order aspherical cross section can be used. However, a fine, in particular wave-shaped or sinusoidal structure is superimposed on all the lens elements here. The periodicity of the structure is smaller here, in particular small compared to the periodicity with which the individual lens elements 4, 5 are disposed one next to the other on the entry surface 2 or the exit surface 3. Such a fine structure which is applied to the lens elements 4, 5 permits the light distribution which exits the individual lens elements or the entire device to be averaged so that the disruption illustrated in FIG. 2 can be reduced.

In a further embodiment of the present invention, likewise not illustrated, a structure is applied to the individual lens elements 4, 5. This is implemented according to a method in accordance with the invention in that in a first step a substrate is provided with lens elements that have a regular cross section such as, for example, a second order spherical or aspherical cross section. Subsequent to this, the light distribution of light that passes through such a lens element is determined. Such light distribution could correspond, for example, to the light distribution according to FIG. 2. Subsequent to this, either the lens elements which are already present are changed in such a way that they have a structure which is complementary, for example, to the disruption which has already been illustrated in FIG. 2, or else new lens elements which have a cross section which is provided with a structure which is complementary, for example, to FIG. 2, are produced in a new substrate or in the same substrate.

In particular, in this way a structure which varies with a larger amplitude in the edge region of the lens element than in the central region of the lens is applied to a lens element with a second order spherical or aspherical cross section.

1. A device for homogenizing optical beams, comprising:
at least one optically functional boundary surface through which a beam to be homogenized can pass or at which the beam to be homogenized can be reflected; and
a plurality of elements, selected from the group consisting of lens elements and mirror elements, disposed on said at least one optically functional boundary surface, said elements each having an edge region with a curvature for reducing diffraction-related effects.

2. The device according to claim 1, wherein said elements each have a central region having a cross section corresponding substantially to a second order aspherical cross section.

3. The device according to claim 1, wherein said edge region of each of said elements has a cross section deviating from a second order aspherical cross section.

4. The device according to claim 1, wherein said edge region of each of said elements has a cross section dominated by relatively high orders of a polynomial.

5. A device for homogenizing optical beams, comprising:
at least one optically functional boundary surface through which a beam to be homogenized can pass or at which the beam to be homogenized can be reflected; and
a plurality of elements, selected from the group consisting of lens elements and mirror elements, disposed on said at least one optically functional boundary surface, each of said elements has a structure selected from the group consisting of a wave-shaped structure and a sinusoidal structure.

6. The device according to claim 5, wherein a periodicity of said structure is smaller, in particular small compared to the periodicity, with which individual ones of said elements are disposed one next to another.

7. The device according to claim 5, wherein each of said elements has a base structure on which said structure is based and is second order spherical or aspherical.

8. The device according to claim 4, wherein said relatively high orders of a polynomial are relatively high even-numbered orders of the polynomial.

9. The device according to claim 2, wherein said cross section is selected from the group consisting of a hyperbolic cross section and a parabolic cross section.

10. A method for manufacturing a device for homogenizing optical beams, the device having a boundary surface through which a beam to be homogenized can pass or at which the beam to be homogenized can be reflected, which comprises the steps of:
forming a body for homogenizing the optical beams, the body having the at least one optically functional boundary surface and a plurality of elements, selected from the group
consisting of lens elements and mirror elements, disposed on the at least one optically functional boundary surface;
determining a light distribution of light passing through an individual one of said lens elements of the plurality of elements or of light reflected by an individual one of the mirror elements of the plurality of elements; and
applying a structure being complementary to the light distribution determined to each of the elements.

11. The method according to claim 10, which further comprises forming the structure to have a larger amplitude in an edge region of the elements than in a central region of the elements.

12. The method according to claim 10, which further comprises producing the elements with a regular cross section.

13. The method according to claim 10, which further comprises producing the elements with a cross section selected from the group consisting of a second order spherical cross section and an aspherical cross section.
